(19) United States
(12) Patent Application Publication
(10) Pub. No.: US 2025/0333277 A1
(43) Pub. Date: Oct. 30, 2025

(54) HEAD GUARD OF INDUSTRIAL VEHICLE, INDUSTRIAL VEHICLE, AND ROOF MEMBER OF INDUSTRIAL VEHICLE

(71) Applicant: KABUSHIKI KAISHA TOYOTA JIDOSHOKKI, Aichi (JP)

(72) Inventor: Tokio YAMASAKI, Aichi (JP)

(73) Assignee: KABUSHIKI KAISHA TOYOTA JIDOSHOKKI, Aichi (JP)

(21) Appl. No.: 19/187,048

(22) Filed: Apr. 23, 2025

(30) Foreign Application Priority Data
Apr. 30, 2024 (JP) 2024-073856

(51) Int. Cl. B66F 9/075

(52) U.S. Cl. CPC B66F 9/07545

(57) ABSTRACT

A head guard of an industrial vehicle includes: a protruding portion provided immediately above a driver's seat of the industrial vehicle having a cargo handling device capable of loading a cargo, the protruding portion protruding upward; and a flat plate portion provided closer to the cargo handling device than the protruding portion and provided above the driver's seat, in which the protruding portion and the flat plate portion are both inclined toward any one of a front side and a rear side in a front-rear direction connecting the cargo handling device and the driver's seat, and at least the flat plate portion has visible light transmittance.

### CROSS-REFERENCE TO RELATED APPLICATIONS

This application is based on and claims the benefit of priority from Japanese Patent Application No. 2024-073856 filed on Apr. 30, 2024, and the entire contents of which are incorporated herein by reference.

### TECHNICAL FIELD

The present disclosure relates to a head guard of an industrial vehicle, an industrial vehicle, and a roof member of an industrial vehicle.

### BACKGROUND

U.S. Pat. No. 9,481,555 discloses an industrial vehicle. The industrial vehicle includes an assembly plate having an opening, a roof supported within the opening of the assembly plate, and a circumferentially-shaped frame elastically connected to the roof.

### SUMMARY

Incidentally, in some cases, the industrial vehicle is used or stored under an environment in which a liquid may fall from above the industrial vehicle toward a head guard, such as outdoors affected by rainfall. In this case, the liquid may accumulate on the head guard extending in a horizontal direction. When the industrial vehicle is moved in a state where the liquid is accumulated, the liquid may fall on a user who rides on the industrial vehicle, which may deteriorate operability and comfort. In addition, when the liquid accumulated on the head guard having transparency serves as a lens, sunlight transmitted through the liquid and the head guard is condensed, and a part of the configuration of the industrial vehicle may become high in temperature. Therefore, there has been a demand for a head guard of an industrial vehicle, an industrial vehicle having the head guard, and a roof member of an industrial vehicle that have a structure in which a liquid is less likely to accumulate and can appropriately ensure visibility of an upper portion.

Therefore, an object of the present disclosure is to provide a head guard of an industrial vehicle, an industrial vehicle, and a roof member of an industrial vehicle that have a structure in which a liquid is less likely to accumulate and can appropriately ensure visibility of an upper portion.

A head guard of an industrial vehicle according to one aspect of the present disclosure includes: a protruding portion provided immediately above a driver's seat of the industrial vehicle having a cargo handling device capable of loading a cargo, the protruding portion protruding upward; and a flat plate portion provided closer to the cargo handling device than the protruding portion and provided above the driver's seat, in which the protruding portion and the flat plate portion are both inclined toward any one of a front side and a rear side in a front-rear direction connecting the cargo handling device and the driver's seat, and at least the flat plate portion has visible light transmittance.

In the head guard of the industrial vehicle, since both the protruding portion and the flat plate portion are inclined toward any one side in the front-rear direction, a liquid falling on the head guard is guided in an inclination direction. Therefore, since the liquid is less likely to accumulate on the protruding portion and the flat plate portion, the possibility that the liquid falls on a user riding on the industrial vehicle is reduced even when the industrial vehicle is moved, and operability and comfort can be appropriately ensured. In addition, heating of a part of the configuration of the industrial vehicle to a high temperature due to condensation of sunlight transmitted through the liquid and the head guard is suppressed. In addition, the user can visually recognize an upper portion through the flat plate portion on which the liquid is less likely to accumulate. Furthermore, since the protruding portion is provided immediately above the driver's seat, it is possible to improve the comfort of the user seated in the driver's seat. Furthermore, since the flat plate portion is provided closer to the cargo handling device than the protruding portion, for example, the flat plate portion can be provided between the viewpoint of the user and the cargo handling device moved upward, so that the visibility of the upper portion can be appropriately ensured. Therefore, the head guard of the industrial vehicle has a structure in which a liquid is less likely to accumulate, and the visibility of the upper portion can be appropriately ensured.

According to the present disclosure, it is possible to provide a head guard of an industrial vehicle, an industrial vehicle, and a roof member of an industrial vehicle that have a structure in which a liquid is less likely to accumulate and can appropriately ensure visibility of an upper portion.

### BRIEF DESCRIPTION OF THE DRAWINGS

FIG. 1 is a side view illustrating a forklift which is an example of an industrial vehicle including a head guard according to one embodiment;

FIG. 2 is a perspective view illustrating an example of the head guard and a roof member of the industrial vehicle according to the embodiment;

FIG. 3 is another perspective view of the example of the head guard and the roof member of the industrial vehicle illustrated in FIG. 2 as viewed from another angle;

FIG. 4 is a plan view illustrating the example of the head guard and the roof member of the industrial vehicle according to the embodiment;

FIG. 5 is a perspective view illustrating an example of a support member and a bar member included in the head guard of the industrial vehicle according to the embodiment;

FIG. 6 is a cross-sectional view illustrating an example of the roof member included in the head guard of the industrial vehicle according to the embodiment;

FIG. 7 is a cross-sectional view illustrating the example of the head guard and the roof member of the industrial vehicle taken along line VII-VII illustrated in FIG. 4; and

FIG. 8 is a cross-sectional view illustrating the example of the head guard and the roof member of the industrial vehicle taken along line VIII-VIII illustrated in FIG. 4.

### DETAILED DESCRIPTION

Hereinafter, embodiments of the present disclosure will be described in detail with reference to the drawings. Note that in the drawings, the same or corresponding parts are denoted by the same reference signs, and redundant description will be omitted. In addition, an X-axis direction, a Y-axis direction, and a Z-axis direction in the following description are axis directions orthogonal to each other in an orthogonal coordinate system of a three-dimensional space. The X-axis direction and the Y-axis direction are, for example, horizontal directions. For example, the X-axis direction is one horizontal direction, and the Y-axis direction is one horizontal direction intersecting the X-axis direction. In the present embodiment, a positive direction in the X-axis direction is referred to as “rightward or a right side”, a negative direction in the X-axis direction is referred to as “leftward or a left side”, and the X-axis direction is referred to as a “left-right direction”. In the present embodiment, a positive direction in the Y-axis direction is referred to as “forward or a front side”, a negative direction in the Y-axis direction is referred to as “rearward or a rear side”, and the Y-axis direction is referred to as a “front-rear direction”. The left-right direction is an example of a direction intersecting the front-rear direction. The Z-axis direction is, for example, an up-down direction (vertical direction). In the present embodiment, a positive direction in the Z-axis direction is referred to as “upward or above”, and a negative direction in the Z-axis direction is referred to as “downward or below”.

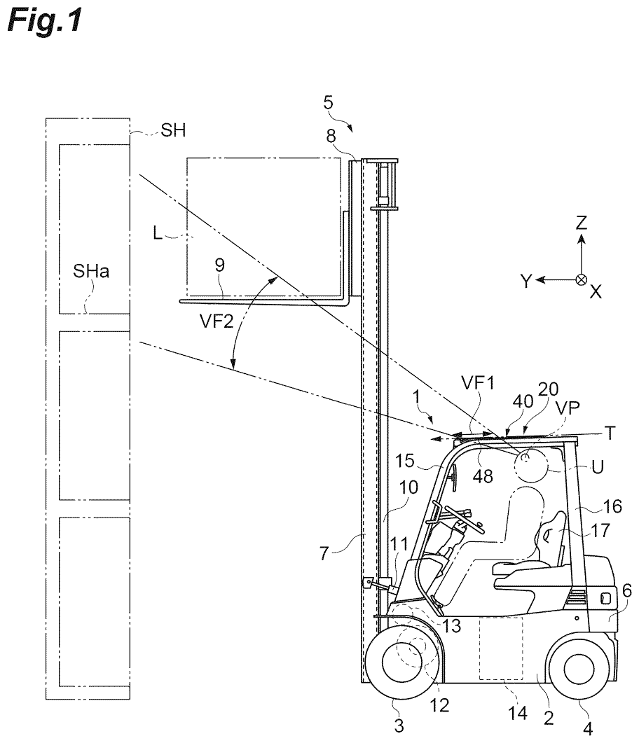

FIG. 1 is a side view illustrating a forklift that is an industrial vehicle including a head guard according to the embodiment of the present disclosure. In FIG. 1, a forklift 1 which is an example of an industrial vehicle is, for example, a counterbalance type electric forklift. The forklift 1 is an industrial vehicle that performs cargo handling.

A vehicle body 2, a pair of driving wheels 3 disposed at a front portion of the vehicle body 2, a pair of steering wheels 4 disposed at a rear portion of the vehicle body 2, and a cargo handling device 5 disposed on a front side of the vehicle body 2 are provided. The pair of driving wheels 3 and the pair of steering wheels 4 can be grounded to a floor surface extending in the horizontal direction and rotate. A counter weight 6 for balancing the vehicle body 2 in the front-rear direction is mounted on the rear portion of the vehicle body 2.

The cargo handling device 5 includes a mast 7 erected at a front end portion of the vehicle body 2, a pair of forks 9 attached to the mast 7 via a lift bracket 8, a lift cylinder 10 that raises and lowers the forks 9, and a tilt cylinder 11 that tilts the mast 7. The cargo handling device 5 is an example of a cargo handling device. The fork 9 is a portion on which a cargo L can be loaded. The cargo handling device 5 can place the cargo L on a placement surface SHa of a shelf SH. The placement surface SHa is, for example, the uppermost stage of the shelf SH.

In addition, the forklift 1 includes a traveling motor 12, a cargo handling motor 13, and a battery pack 14. The battery pack 14 is a power supply source for the traveling motor 12 and the cargo handling motor 13.

The traveling motor 12 is an AC motor that rotates the driving wheels 3. When the traveling motor 12 is rotationally driven, the driving force of the traveling motor 12 is transmitted to the driving wheels 3 via a speed reducer, and the driving wheels 3 rotate. In addition, the traveling motor 12 also functions as a generator. Specifically, at the time of braking of the forklift 1, the traveling motor 12 operates as a generator by the rotation of the driving wheel 3. That is, regenerative braking of the traveling motor 12 is performed, and regenerative power is generated from the traveling motor 12.

The cargo handling motor 13 is an AC motor that drives a hydraulic pump (not illustrated) that supplies hydraulic oil to the lift cylinder 10 and the tilt cylinder 11. An oil control valve that switches a flow direction of the hydraulic oil is disposed between the hydraulic pump (not illustrated) and the lift cylinder 10 and tilt cylinder 11.

The vehicle body 2 further includes a driver's seat 17 and a head guard 20. The head guard 20 includes a pair of left and right front pillars 15 and a pair of left and right rear pillars 16. The rear pillar 16 is disposed behind the front pillar 15. The driver's seat 17 is provided between the pair of left and right front pillars 15 and the pair of left and right rear pillars 16 in the horizontal direction. The driver's seat 17 is configured to allow a user U to be seated (ride on). The driver's seat 17 has a seat surface on which the user U can be seated. The size of the seat surface is, for example, a value obtained by adding a predetermined area to a statistic such as an average value or a median value of the size of the buttocks of the user U who rides on or is estimated to ride on the forklift 1. The user U seated in the driver's seat 17 can visually recognize, for example, at least one of a lower portion of the cargo handling device 5 and a space below the cargo handling device 5 through the head guard 20.

The front pillar 15 of the present embodiment is inclined rearward toward an upper portion thereof. The front pillar 15 has, for example, a side pillar 15a extending in the front-rear direction in the upper portion. A rear end portion of the side pillar 15a is coupled to an upper end portion of the rear pillar 16. That is, the side pillar 15a constituting at least a part of the upper portion of the front pillar 15 is provided above the driver's seat 17. The head guard 20 is coupled between the pair of left and right side pillars 15a. The head guard 20 is provided above the driver's seat 17.

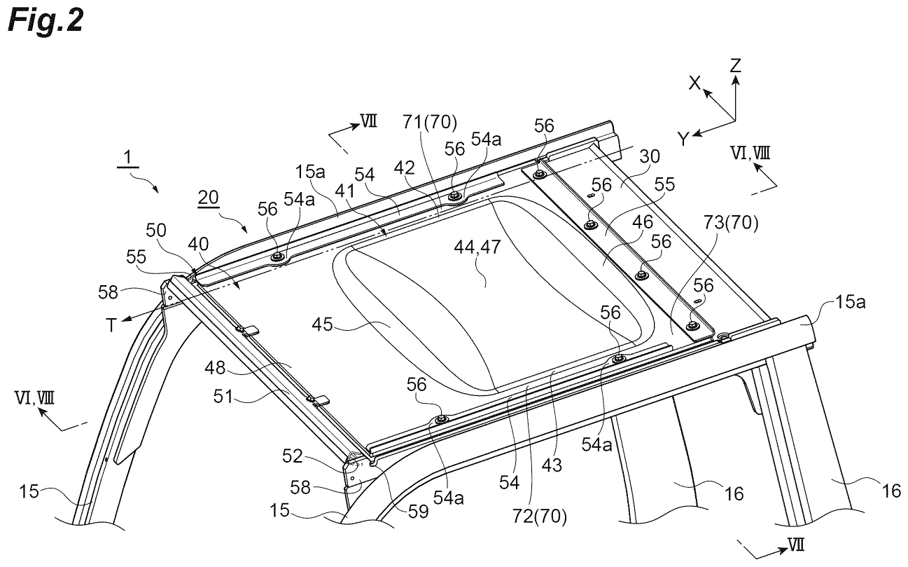

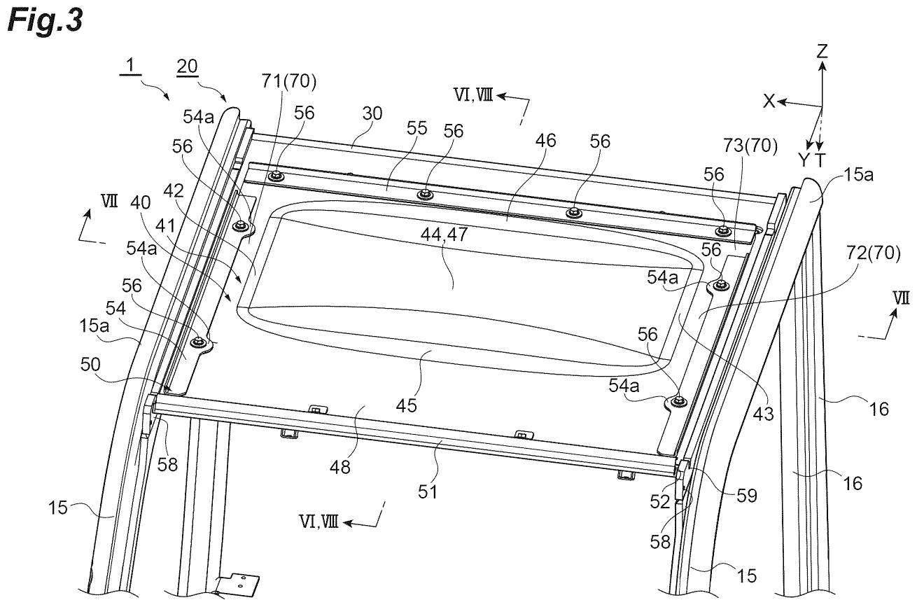

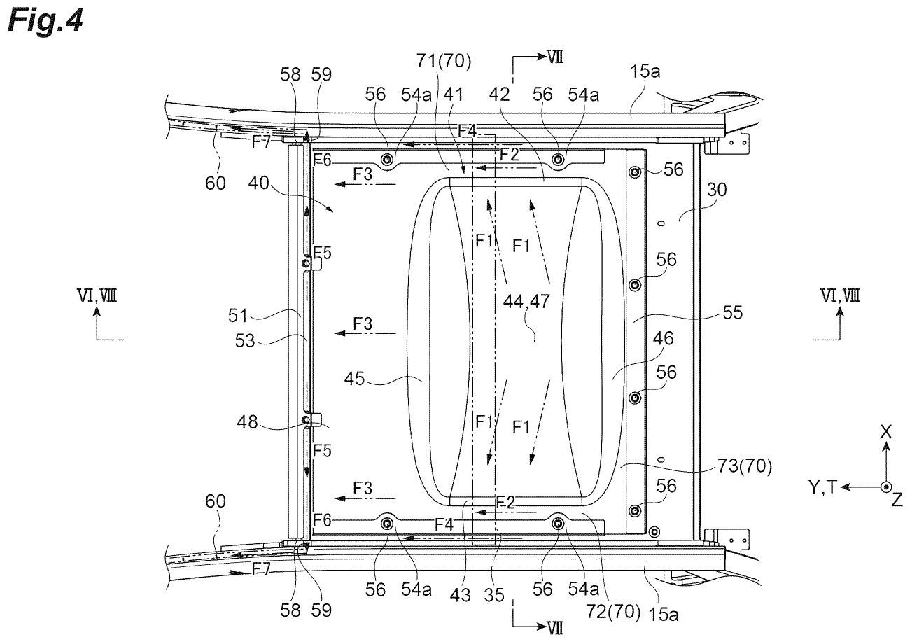

FIG. 2 is a perspective view illustrating an example of the head guard and a roof member of the industrial vehicle according to the embodiment. FIG. 3 is another perspective view of the example of the head guard and the roof member of the industrial vehicle illustrated in FIG. 2 as viewed from another angle. FIG. 4 is a plan view illustrating the example of the head guard and the roof member of the industrial vehicle according to the embodiment. As illustrated in FIGS. 2 to 4, the head guard 20 includes a support member 30, a roof member 40, and a water guiding portion 50. Note that “water guiding” in the present embodiment includes guiding and flowing a liquid. “Drain” includes excluding a liquid. “Overflow” includes overflowing of a liquid. The liquid includes rainwater and water such as factory water.

The support member 30 supports the roof member 40 from below. The support member 30 is a flat plate-shaped member. The support member 30 is inclined toward any of the front side and the rear side in the front-rear direction connecting the cargo handling device 5 and the driver's seat 17. As illustrated in FIGS. 2 and 3, the support member 30 extends along an inclination direction T that is along the front-rear direction and is inclined downward toward the front side, and the left-right direction. The inclination direction T is inclined downward at an angle within a range of more than 0 degrees and less than 10 degrees with respect to the front-rear direction (horizontal direction). The inclination direction T of the present embodiment intersects the left-right direction and the up-down direction, and is inclined downward at a predetermined angle within a range of 1 degree or more and 3 degrees or less toward the front side. The inclination direction T is along the Y axis in the left-right direction.

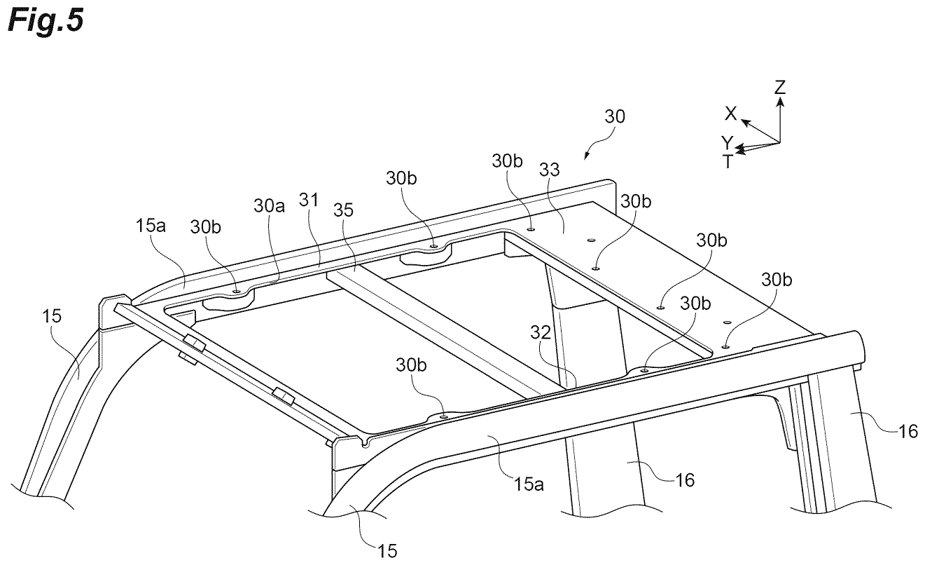

FIG. 5 is a perspective view illustrating an example of the support member and a bar member included in the head guard of the industrial vehicle according to the embodiment. As illustrated in FIG. 5, the support member 30 is a frame-shaped member in which at least one opening 30a penetrating in the up-down direction is formed. In the example illustrated in FIG. 5, one opening 30a having a rectangular shape is formed at a central portion of the support member 30. The one opening 30a is larger than the driver's seat 17 in the front-rear direction and the left-right direction. Therefore, in the example illustrated in FIG. 5, the opening 30a provided in the support member 30 is not formed in a lattice shape. That is, a portion that blocks between the roof member 40 and the user U is not formed in the support member 30.

The support member 30 includes a right end portion 31 and a left end portion 32 extending in the front-rear direction, and a rear end portion 33 extending in the left-right direction. A rear combination lamp is provided (not illustrated) in a portion behind the rear end portion 33 of the support member 30.

The head guard 20 further includes a bar member 35. The bar member 35 extends across at least one opening 30a of the support member 30 in the left-right direction, and is fixed to the support member 30. The bar member 35 extends in the left-right direction and has a rectangular parallelepiped shape. The bar member 35 is fixed to a lower surface of the right end portion 31 and a lower surface of the left end portion 32 of the support member 30 by welding or the like. The bar member 35 is provided, for example, immediately below a protruding portion 41 described later. The bar member 35 is provided, for example, immediately below a front end portion 45 of the protruding portion 41 described later. That is, the bar member 35 is disposed away from the roof member 40. When the roof member 40 is bent downward by an impact applied to the roof member 40, such as when an object falls on the roof member 40, the bar member 35 abuts on the bent roof member 40 to suppress the downward bending of the roof member 40. Note that the bar member 35 may be the same member as the support member 30 and integrally molded with the support member 30.

The support member 30 has a plurality of female screw portions 30b used for coupling a pair of second water guiding portions 54 and a third water guiding portion 55 described later. In the example illustrated in FIG. 5, in the support member 30, two female screw portions 30b are formed at the right end portion 31, two female screw portions 30b are formed at the left end portion 32, and four female screw portions 30b are formed at a front portion of the rear end portion 33.

The roof member 40 illustrated in FIGS. 2 to 4 covers the driver's seat 17 from above. The roof member 40 covers the entire opening 30a of the support member 30 from above. As a result, getting wet of the driver's seat 17 due to water falling from above is suppressed. The roof member 40 has, for example, a thin plate shape. The material of the roof member 40 is, for example, resin. The roof member 40 is integrally molded. The roof member 40 is inclined toward any one of the front side and the rear side in the front-rear direction connecting the cargo handling device 5 and the driver's seat 17. Since the roof member 40 is provided on the support member 30, the roof member 40 extends along the inclination direction T and the left-right direction. The support member 30 extends longer rightward and leftward than the roof member 40. The roof member 40 is fixed to the support member 30 by a fixing portion 56 described later. The roof member 40 covers the opening 30a of the support member 30, and is supported with an outer edge portion of the roof member 40 fixed to the support member 30. In the outer edge portion of the roof member 40, for example, a plurality of openings through which later-described male screws of the fixing portion 56 can be inserted are formed.

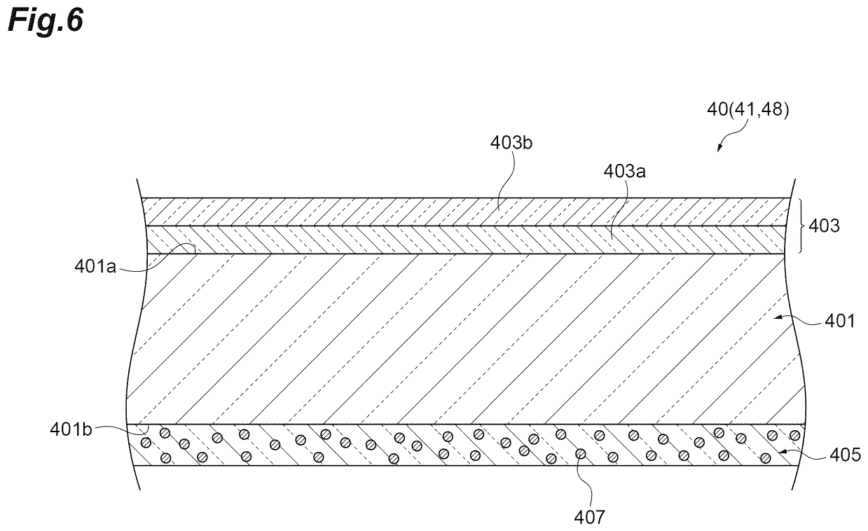

The configuration of the roof member 40 will be described in detail. A coating layer is provided on at least one of an upper surface and a lower surface of the roof member 40. That is, the coating layer is provided on at least one of an upper surface and a lower surface of each of the protruding portion 41 and a flat plate portion 48 described later. The coating layer protects a substrate on which the coating layer is formed. FIG. 6 is a cross-sectional view illustrating an example of the roof member included in the head guard of the industrial vehicle according to the embodiment. In the example illustrated in FIG. 6, the roof member 40 includes a substrate 401, a first coating layer 403, and a second coating layer 405.

The substrate 401 is made of a transparent resin, and has an outer surface 401a facing upward (outside the vehicle) and an inner surface 401b facing downward (inside the vehicle). The substrate 401 is made of a colorless transparent polycarbonate. The substrate 401 is formed based on the shape and size of the opening 30a of the support member 30, and has a plate thickness of about 5 mm to 8 mm.

The first coating layer 403 is integrally formed on the outer surface 401a of the substrate 401. As a result, the first coating layer 403 faces an upper space. The first coating layer 403 is formed of a colorless transparent resin. More specifically, the first coating layer 403 has a two-layer structure of a primer layer 403a made of a colorless transparent acrylic resin and a surface layer 403b made of a colorless transparent silicone resin. The primer layer 403a is formed on the outer surface 401a of the substrate 401 and is in contact with the outer surface 401a. The surface layer 403b is formed on the primer layer 403a and is in contact with the upper space. The surface layer 403b is formed smoothly. As a result, the first coating layer 403 is smooth. Note that the primer layer 403a may be formed of resin other than the acrylic resin, and the surface layer 403b may be formed of resin other than the silicone resin. In addition, the first coating layer 403 may have a single-layer structure.

The second coating layer 405 is integrally formed on the inner surface 401b of the substrate 401. As a result, the second coating layer 405 faces a lower space. The second coating layer 405 contains a colorless transparent acrylic resin as a main component. In addition, the second coating layer 405 has a single-layer structure unlike the first coating layer 403. Note that the second coating layer 405 may be formed of resin other than the acrylic resin. The second coating layer 405 contains a plurality of reflective particles 407 that reflect sunlight (infrared rays, visible rays, ultraviolet rays). The plurality of reflective particles 407 are buried in the second coating layer 405. Note that the second coating layer 405 may have a function of absorbing sunlight. In addition, in FIG. 6, in order to facilitate the description, the particle diameter of the reflective particle 407 is exaggerated in addition to the thickness of each of the substrate 401, the first coating layer 403, and the second coating layer 405.

The roof member 40 illustrated in FIGS. 2 to 4 includes the protruding portion 41 and the flat plate portion 48. The roof member 40 further includes an extending portion 70. Each of the protruding portion 41, the flat plate portion 48, and the extending portion 70 of the present embodiment indicates a portion of the roof member 40. That is, the roof member 40 including the protruding portion 41, the flat plate portion 48, and the extending portion 70 is integrally molded. In the roof member 40, at least the flat plate portion 48 has visible light transmittance. The protruding portion 41 and the extending portion 70 of the present embodiment have visible light transmittance, for example, similarly to the flat plate portion 48. That is, the user U seated in the driver's seat 17 can visually recognize the upper space through the protruding portion 41, the flat plate portion 48, and the extending portion 70. The protruding portion 41, the flat plate portion 48, and the extending portion 70 are inclined together toward any one of the front side and the rear side in the front-rear direction. That is, the protruding portion 41, the flat plate portion 48, and the extending portion 70 are inclined in the same direction. The protruding portion 41, the flat plate portion 48, and the extending portion 70 of the present embodiment extend in the inclination direction T and the left-right direction. In the front-rear direction, the length of the protruding portion 41 is longer than the length of the flat plate portion 48.

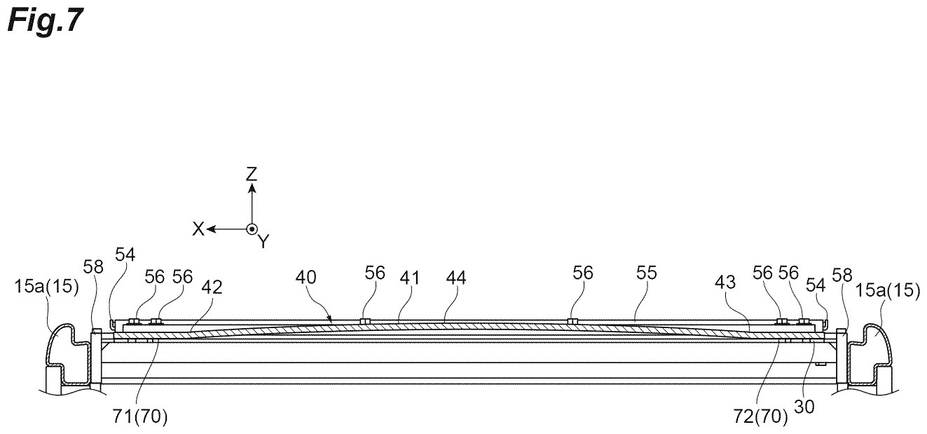

The protruding portion 41 is provided immediately above the driver's seat 17 and protrudes upward. FIG. 7 is a cross-sectional view illustrating the example of the head guard and the roof member of the industrial vehicle taken along line VII-VII illustrated in FIG. 4. That is, FIG. 7 is a front view of a cross section of the head guard 20 of the forklift 1. As illustrated in FIG. 7, the protruding portion 41 has a right end portion 42, a left end portion 43, and a central portion 44 located between the right end portion 42 and the left end portion 43 in the left-right direction.

The central portion 44 of the protruding portion 41 protrudes upward in the left-right direction. The central portion 44 has a portion protruding most in the left-right direction. The protruding portion 41 is, for example, a curved portion. The central portion 44 is located higher than the right end portion 42 and the left end portion 43. The protruding portion 41 has a rounded curved surface. The right end portion 42 and the left end portion 43 may be, for example, portions having a larger degree of upward protrusion than that of the central portion 44. A large degree of protrusion indicates, for example, a large curvature. The right end portion 42 and the central portion 44 are coupled by a smooth curved surface portion. The smooth curved surface portion indicates a portion having no unevenness to such an extent that water is accumulated. The left end portion 43 and the central portion 44 are coupled by a smooth curved surface portion. The central portion 44 may be, for example, a flat plate-shaped portion extending in the inclination direction T and the left-right direction. The protruding portion 41 can accommodate, for example, the head of the user seated (riding) on the driver's seat 17 immediately below the central portion 44.

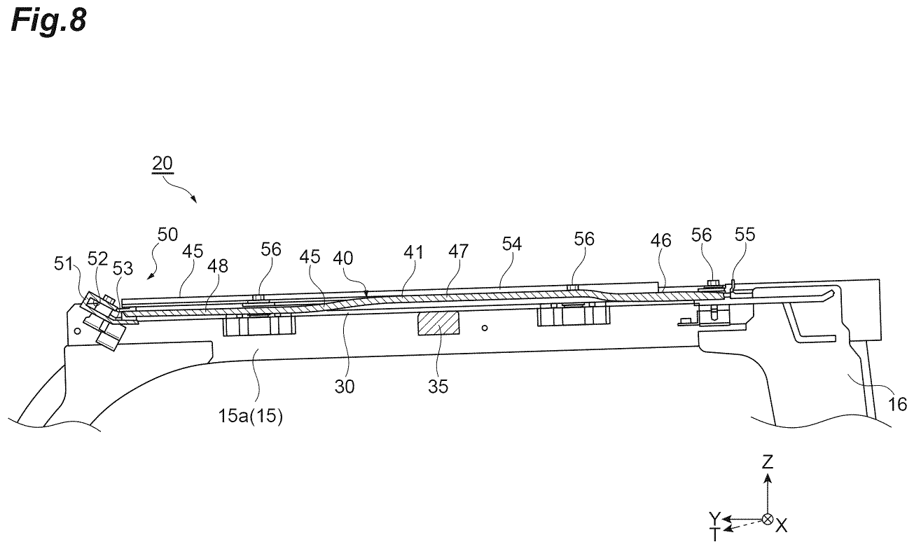

FIG. 8 is a cross-sectional view illustrating the example of the head guard and the roof member of the industrial vehicle taken along line VIII-VIII illustrated in FIG. 4. FIG. 8 is a diagram of a cross section of the head guard 20 of the forklift 1 as viewed from the left side to the right side. As illustrated in FIG. 8, the protruding portion 41 has the front end portion 45, a rear end portion 46, and a central portion 47 located between the front end portion 45 and the rear end portion 46 in the front-rear direction. In the present embodiment, a case where the position of the central portion 47 in the front-rear direction coincides with the position of the central portion 47 in the left-right direction will be described. The front end portion 45 may be a portion that is inclined downward toward the front side with respect to the inclination direction T. The rear end portion 46 may be, for example, a portion that is inclined downward toward the front side.

The rear end portion 46 may have a portion that does not extend along the inclination direction T. In this case, the portion may not extend along the front-rear direction. The portion may be inclined downward at least toward the front side, or may be inclined upward at least toward the front side. When a portion of the rear end portion 46 that does not extend along the inclination direction T extends along the front-rear direction, the portion may have a structure in which the portion is inclined downward from the central portion in the left-right direction toward the left side and the right side. As a result, a liquid present at the portion can be appropriately discharged.

The central portion 47 of the protruding portion 41 protrudes upward in the front-rear direction. The central portion 44 is located higher than the front end portion 45 and the rear end portion 46. The front end portion 45 and the rear end portion 46 may be, for example, portions having a larger degree of upward protrusion than that of the central portion 47. The front end portion 45 and the central portion 47 in the front-rear direction are coupled by a smooth curved surface portion. The rear end portion 46 and the central portion 47 are coupled by a smooth curved surface portion. The central portion 47 may be, for example, a flat plate-shaped portion extending in the inclination direction T and the front-rear direction. The protruding portion 41 can accommodate, for example, the head of the user seated (riding) on the driver's seat 17 immediately below the central portion 47.

As illustrated in FIGS. 2 to 4, the flat plate portion 48 is provided above the driver's seat 17. The flat plate portion 48 is provided closer to the cargo handling device 5 than the protruding portion 41, that is, on the front side. A rear end portion of the flat plate portion 48 of the present embodiment is coupled to, for example, the front end portion 45 of the protruding portion 41. The flat plate portion 48 extends larger than the driver's seat 17 in the left-right direction. The flat plate portion 48 extends along the inclination direction T and the left-right direction, and the upper surface thereof is a smooth surface.

Here, the cargo handling device 5 loads the cargo L onto the shelf SH or the like on which the cargo L can be loaded, or receives the cargo L from the shelf SH. Therefore, as illustrated in FIG. 1, the user U needs to recognize, from a viewpoint VP (the position of the eyes of the user U) of the user U, a distal end portion of the fork 9 and a lower end portion of the cargo L moved to the upper end by the cargo handling device 5. In addition, the user U needs to recognize, from the viewpoint VP, the end of the placement surface SHa to which the shelf SH is to be transferred. The viewpoint VP of the user U is, for example, a statistic such as an average value or a median value of the positions of the eyes of the user U who rides on or is estimated to ride on the forklift 1. Here, a range VF1 visually recognizable from the viewpoint VP of the user U through the flat plate portion 48 can secure a range VF2 above the roof member 40 (for example, a space including the cargo L and the periphery of the cargo handling device 5). A part of the flat plate portion 48 is provided at a position intersecting a straight line connecting the position of the lower end of the cargo handling device 5 or the cargo L that can be loaded on the cargo handling device and the estimated position of the viewpoint VP of the user U who can ride on the driver's seat 17. In the present embodiment, the range VF1 is set such that the lower end portion of the cargo handling device 5 and the lower end portion of the cargo L moved upward by the cargo handling device 5 and estimated to be loaded by the cargo handling device 5 fall within the range VF2. The flat plate portion 48 of the present embodiment extends longer in the front-rear direction than at least the set range VF1.

Referring again to FIGS. 2 to 4. The extending portion 70 is connected to the protruding portion 41 and the flat plate portion 48, and is provided at at least one of both end portions of the protruding portion 41 in the left-right direction. In the example illustrated in FIGS. 2 to 4, the extending portion 70 has a first extending portion 71 provided on the right side of the right end portion 42 of the protruding portion 41 and a second extending portion 72 provided on the left side of the left end portion 43 of the protruding portion 41. That is, the extending portion 70 has a pair of portions and is disposed such that the pair of portions sandwich the protruding portion 41 therebetween in the left-right direction. The first extending portion 71 and the second extending portion 72 are inclined together with the protruding portion 41 and the flat plate portion 48 and extend in a flat plate shape along the flat plate portion 48. The first extending portion 71 and the second extending portion 72 extend along the inclination direction T and the left-right direction. The first extending portion 71 and the second extending portion 72 are disposed so as to be flush with the flat plate portion 48. The first extending portion 71 and the second extending portion 72 may be disposed higher than the flat plate portion 48. The first extending portion 71 and the second extending portion 72 are provided with two openings (not illustrated) arranged in the front-rear direction. The opening penetrates in the up-down direction, and the male screw of the fixing portion 56 described later can be inserted into the opening. The opening may be threaded.

The extending portion 70 may further include a third extending portion 73 connected to the protruding portion 41, the first extending portion 71, and the second extending portion 72 and provided behind the rear end portion 46 of the protruding portion 41. When the inclination direction T is inclined downward toward the rear side and the flat plate portion 48 is provided on the rear side, the third extending portion 73 may be provided on the front side of the front end portion 45 of the protruding portion 41. That is, the extending portion 70 is a U-shaped portion and is disposed so as to surround the protruding portion 41 in the left-right direction. The third extending portion 73 is inclined together with the protruding portion 41 and the flat plate portion 48 and extends in a flat plate shape along the first extending portion 71 and the second extending portion 72. The third extending portion 73 extends along the inclination direction T and the left-right direction. The third extending portion 73 is disposed so as to be flush with the first extending portion 71 and the second extending portion 72. The third extending portion 73 may be disposed higher than the first extending portion 71 and the second extending portion 72. In the third extending portion 73, four openings (not illustrated) are provided side by side in the left-right direction. The opening penetrates in the up-down direction, and the male screw of the fixing portion 56 described later can be inserted into the opening. The opening may be threaded.

The water guiding portion 50 includes a first water guiding portion 51, at least one second water guiding portion 54, the third water guiding portion 55, the fixing portion 56, and a pair of side plates 58. The first water guiding portion 51 has a function of guiding a liquid flowing down forward toward the pair of front pillars 15. The first water guiding portion 51 is disposed in front of the roof member 40. The first water guiding portion 51 is provided at the front end portion of the support member 30. The first water guiding portion 51 extends along the left-right direction. The first water guiding portion 51 extends to the outside (left side and right side) of the pair of second water guiding portions 54 described later. The first water guiding portion 51 is coupled to the pair of side plates 58.

The first water guiding portion 51 has a recessed portion 52 (see FIG. 2) and a water passage portion 53 (see FIG. 4). The recessed portion 52 is recessed forward and extends along the left-right direction. The inside of the recessed portion 52 is inclined downward toward the rear side, for example. For example, the recessed portion 52 is recessed so as to be inclined upward toward the front side. That is, the first water guiding portion 51 is a portion where a groove (recessed portion) extending so as to cover a part of the upper side is formed. An upper surface of a portion forming the recessed portion 52 is inclined downward toward the rear side. The water passage portion 53 is located behind the recessed portion 52. The water passage portion 53 extends along the left-right direction. Although not illustrated in the drawing, a central portion of the water passage portion 53 protrudes most upward in the left-right direction, and is inclined downward from the central portion toward the right side and from the central portion toward the left side.

The at least one second water guiding portion 54 has a function of pressing the roof member 40 from above and a function of guiding a liquid flowing down toward the pair of side pillars 15a in the roof member 40 forward. In the present embodiment, the water guiding portion 50 includes the pair of second water guiding portions 54 as at least one second water guiding portion 54. The pair of second water guiding portions 54 are respectively provided on the first extending portion 71 and the second extending portion 72 of the roof member 40. The pair of second water guiding portions 54 extend in the front-rear direction at the first extending portion 71 and the right end portion of the flat plate portion 48 and at the second extending portion 72 and the left end portion of the flat plate portion 48, and can guide water in the front-rear direction. Each of the second water guiding portions 54 has at least one insertion portion 54a through which the fixing portion 56 is inserted.

Each of the second water guiding portions 54 is, for example, an L-shaped metal member. The second water guiding portion 54 includes a first portion having a substantially rectangular plate shape, provided with the insertion portion 54a, and extending in the inclination direction T and the left-right direction and a second portion having a substantially rectangular plate shape and extending in the inclination direction T and the up-down direction. The first portion is provided on the inner side (central portion 44 side) as compared with the second portion. The first portion of the second water guiding portion 54 may extend so as to be coupled to a first portion of the third water guiding portion 55 described later. That is, the second water guiding portion 54 and the third water guiding portion 55 may be provided so as to surround an upper surface of the first extending portion 71, an upper surface of the second extending portion 72, and an upper surface of the third extending portion 73 of the roof member 40.

In the example illustrated in FIGS. 2 to 4, each of the second water guiding portions 54 is provided with two insertion portions 54a arranged in the front-rear direction. Each of the insertion portions 54a is curved and protrudes inward (toward the central portion 44). Each of the insertion portions 54a has a surface on which a washer of the fixing portion 56 described later can abut. The insertion portion 54a has an opening (not illustrated) penetrating in the up-down direction. The opening may be threaded.

The third water guiding portion 55 has a function of pressing the roof member 40 from above and a function of suppressing (blocking) flowing down of liquid to the rear side (rear combination lamp side). The third water guiding portion 55 is provided on the third extending portion 73 of the roof member 40. The third water guiding portion 55 extends along the left-right direction. The third water guiding portion 55 is, for example, an L-shaped metal member. The third water guiding portion 55 has a first portion having a substantially rectangular plate shape and extending in the inclination direction T and the left-right direction, and a second portion having a substantially rectangular plate shape and extending in the left-right direction and the up-down direction. The first portion is provided on the inner side (central portion 44 side) as compared with the second portion. The third water guiding portion 55 has an opening (not illustrated) that penetrates in the up-down direction and through which the fixing portion 56 can be inserted. The opening may be threaded. The third water guiding portion 55 has a surface on which a washer of the fixing portion 56 described later can abut.

The fixing portion 56 is used for fixing the pair of second water guiding portions 54, the roof member 40, and the support member 30, and for fixing the third water guiding portion 55, the roof member 40, and the support member 30. For example, the fixing portion 56 includes a plurality of male screws and a plurality of washers. The male screw is, for example, a bolt having a threaded insertion portion and a head portion having a diameter larger than that of the threaded insertion portion. The washers are located between the head portions of the male screws and the pair of second water guiding portions 54 and third water guiding portion 55. The male screws are inserted through the washers, the openings formed in a plurality of targets (the pair of second water guiding portions 54 and the third water guiding portion 55) to be fixed, the openings formed in the roof member 40, and the female screw portions 30b (see FIG. 5) formed in the support member 30 in this order from the upper side to the lower side, and are screwed with the female screw portions 30b. The one second water guiding portion 54 is provided on the upper surface of the first extending portion 71 and above the right end portion 31 (see FIG. 5) of the support member 30. The other second water guiding portion 54 is provided on the upper surface of the second extending portion 72 and above the left end portion 32 (see FIG. 5) of the support member 30. The third water guiding portion 55 is provided on the upper surface of the third extending portion 73 and above the rear end portion 33 (see FIG. 5) of the support member 30. Since the pair of second water guiding portions 54 and the third water guiding portion 55 approach the support member 30 by the screwing of the fixing portion 56, the roof member 40 is sandwiched between the pair of second water guiding portions 54 and third water guiding portion 55 and the support member 30, and is fixed to the support member 30.

The pair of side plates 58 are members that are provided at both end portions of at least one of the protruding portion 41 and the flat plate portion 48 in the left-right direction, extend in the front-rear direction, and can guide water in the front-rear direction. As illustrated in FIGS. 3 to 5, the pair of side plates 58 are respectively provided on the right side of the right end portions of the support member 30 and the roof member 40 and on the left side of the left end portions of the support member 30 and the roof member 40. The pair of side plates 58 are respectively fixed to, for example, a side surface facing rightward and a side surface facing leftward of the support member 30. The pair of side plates 58 are provided at positions sandwiched between the side pillars 15a of the pair of front pillars 15. That is, the roof member 40 and the pair of second water guiding portions 54 are provided at positions sandwiched between the pair of side plates 58.

Each of the side plates 58 extends along the inclination direction T and the up-down direction. Each of the side plates 58 has a substantially rectangular plate shape. Each of the side plates 58 extends longer than a length connecting the first water guiding portion 51 to the third water guiding portion 55 in the inclination direction T. Each of the side plates 58 extends at least from the lateral side of the first water guiding portion 51 to the lateral side of the third water guiding portion 55. Each of the side plates 58 may extend to, for example, a rear end of the rear pillar 16.

Each of the side plates 58 extends higher than the support member 30. As a result, when a liquid flows down rightward and leftward from the roof member 40, the liquid flows down on the support member 30, but each of the side plates 58 can suppress flowing down of the liquid to the side pillar 15a side. Therefore, the liquid flowing down rightward and leftward from the roof member 40 flows down in the inclination direction T along each of the side plates 58.

A drain port through which water can be drained from at least one end portion in the left-right direction is formed in the water guiding portion 50. In the example illustrated in FIG. 4, a drain port 59 penetrating in the left-right direction is formed in a front end portion of each of the side plates 58. The drain port 59 may be a notch that is open upward. Although not illustrated in the drawing, for example, the drain port 59 opens to the same height as a right end portion and a left end portion of the water passage portion 53. As a result, the liquid flowing down along the water passage portion 53 and each of the side plates 58 is discharged toward the front pillar 15 through the drain port 59.

For example, the front pillar 15 is provided with a pipe 60 (see FIG. 4) and a hose (not illustrated) through which a liquid can flow down. An opening at an upper end of the pipe is provided immediately below the drain port 59. The hose is connected to a lower end portion of the pipe. The liquid discharged from the drain port 59 is guided toward the pipe. The liquid flowing down in the pipe is guided from the pipe to the hose and discharged below the head guard 20.

Here, how the liquid falling on the roof member 40 flows down will be described in detail with reference to FIG. 4. Since the protruding portion 41 is curved upward in the left-right direction and the front-rear direction and is inclined in the inclination direction T, the liquid falling on the central portions 44 and 47 of the protruding portion 41 flows down rightward and in the inclination direction T or leftward and in the inclination direction T as indicated by an arrow F1.

Since the roof member 40 is provided with the pair of second water guiding portions 54 at both end portions in the left-right direction, flowing down rightward at the right end portion and flowing down leftward at the left end portion are suppressed. Therefore, the liquid reaching the right end portion 42 and the left end portion 43 of the protruding portion 41 flows down in the inclination direction T along the second water guiding portion 54 as indicated by an arrow F2.

Since the flat plate portion 48 of the roof member 40 is inclined in the inclination direction T, the liquid reaching the flat plate portion 48 flows down toward the first water guiding portion 51 along the inclination direction T as indicated by an arrow F3.

For example, when the amount of liquid falling on the roof member 40 is large, the liquid may overflow from each of the second water guiding portions 54. In addition, depending on the degree of acceleration of the forklift 1, the liquid falling on the rear end portion of the roof member 40 may flow down to the support member 30 from a portion between each of the second water guiding portions 54 and the third water guiding portion 55 in the roof member 40. In these cases, the liquid moves to the upper surface of the support member 30 between the second water guiding portion 54 and the side plate 58 located at the right end portion of the head guard 20 and the upper surface of the support member 30 between the second water guiding portion 54 and the side plate 58 located at the left end portion of the head guard 20. Since the support member 30 is inclined in the inclination direction T, the liquid reaching the upper surface of the support member 30 flows down in the inclination direction T as indicated by an arrow F4.

Since the first water guiding portion 51 is inclined downward from the central portion thereof toward the right side and the left side, the liquid reaching the water passage portion 53 of the first water guiding portion 51 flows down rightward and leftward and flows down toward each of the side plates 58 as indicated by an arrow F5. Since the recessed portion 52 of the first water guiding portion 51 and the upper surface constituting the recessed portion 52 are inclined downward toward the rear side, the liquid flowing down the roof member 40 along the inclination direction T can be received. Since the recessed portion 52 is inclined downward toward the rear side, the possibility that the liquid overflows from the first water guiding portion 51 can be reduced even if the amount of liquid flowing down in the inclination direction T is large.

The liquid flowing down along the arrow F4 and the liquid flowing down along the arrow F5 flow out from the drain port 59 provided in each of the side plates 58 toward the side pillar 15a as indicated by an arrow F6. The liquid flowing out of the drain port 59 flows downward along the pipe 60 provided in the front pillar 15 as indicated by an arrow F7. The liquid flowing down through the pipe 60 is guided from the pipe 60 to the hose (not illustrated) and discharged below the head guard 20. In this manner, accumulation of the liquid falling on the roof member 40 is suppressed on the roof member 40, and the liquid is appropriately drained from the roof member 40.

Next, operational effects of the forklift 1 and the head guard 20 of the present embodiment will be described while describing problems of a conventional forklift (industrial vehicle). A forklift may be used or stored in an environment where a liquid may fall from above the forklift toward a head guard, such as outdoors affected by rainfall. In this case, since the head guard employed in the conventional forklift extends in the horizontal direction, the liquid may accumulate on the head guard. When the forklift is moved in a state where the liquid is accumulated, the liquid may fall on a user who rides on the forklift, which may deteriorate operability and comfort. In addition, when the liquid accumulated on the head guard having transparency serves as a lens, sunlight transmitted through the liquid and the head guard is condensed, and a part of the configuration of the forklift may become high in temperature. Therefore, there has been a demand for a head guard of an industrial vehicle having a structure in which a liquid is less likely to accumulate and capable of appropriately ensuring visibility of an upper portion (upper space), and an industrial vehicle having the head guard.

Here, in the forklift 1 (an example of an industrial vehicle), the head guard 20, and the roof member 40 of the present embodiment, since the protruding portion 41 and the flat plate portion 48 are both inclined toward any one side in the front-rear direction, the liquid falling on the head guard 20 is guided in the inclination direction T. Therefore, since the liquid is less likely to accumulate on the protruding portion 41 and the flat plate portion 48, even when the forklift 1 is moved, the possibility that the liquid falls on the user U riding on the forklift 1 is reduced, and operability and comfort can be appropriately ensured. In addition, heating of a part of the configuration of the forklift 1 to a high temperature due to condensation of sunlight transmitted through the liquid and the head guard 20 is suppressed. In addition, the user U can visually recognize the upper portion through the flat plate portion 48 on which the liquid is less likely to accumulate. Furthermore, since the protruding portion 41 is provided immediately above the driver's seat 17, it is possible to improve the comfort of the user U seated in the driver's seat 17. Furthermore, since the flat plate portion is provided closer to the cargo handling device than the protruding portion 48, for example, the flat plate portion 48 can be provided between the viewpoint of the user and the cargo handling device moved upward, so that the visibility of the upper portion can be appropriately ensured. In addition, when the roof member 40 is inclined downward toward the front side, the protruding portion 41 is inclined sharply on the rear side of the forklift 1 because the protruding portion is provided behind the flat plate portion 48, so that a small amount of liquid can also easily flow down. In addition, the liquid on the flat plate portion 48 can flow down more easily by combining with the liquid flowing down from the protruding portion 41 as described above. Therefore, the forklift 1 and the head guard 20 have a structure in which a liquid is less likely to accumulate, and the visibility of the upper portion can be appropriately ensured. In addition, when the protruding portion provided in the roof member is provided at a position intersecting a straight line connecting a target to be visually recognized by the user U and the estimated position of the viewpoint VP of the user U who can ride on the driver's seat 17, distortion may occur in the visual field of the user U. In particular, when at least a part of the protruding portion is formed of a curved surface, distortion may occur in the visual field. However, since the user U riding on the driver's seat 17 visually recognizes the visual field through the flat plate portion 48, it is possible to ensure the comfort of the user by the protruding portion 41 while securing the visual field with less distortion. That is, the head guard 20 and the roof member 40 of the present embodiment can achieve both improvement in visibility and ensuring of comfort. Note that for example, since the flat plate portion 48 extends larger than the driver's seat 17 in the left-right direction, a wide range of space above the head guard can be visually recognized.

In addition, in the front-rear direction, the length of the protruding portion 41 is longer than the length of the flat plate portion 48. In this case, since the protruding portion 41 is provided immediately above the driver's seat 17 and is long in the front-rear direction, and a wide space is secured above, it is possible to more appropriately ensure the comfort of the user U seated in the driver's seat 17.

In addition, a part of the flat plate portion 48 may be provided at a position intersecting a straight line connecting the position of the lower end of the cargo handling device 5 or the cargo L that can be loaded on the cargo handling device 5 and the estimated position of the viewpoint VP of the user U who can ride on the driver's seat 17. In this case, the user U riding on the driver's seat 17 can visually recognize the position of the lower end of the cargo handling device 5 and the position of the lower end of the cargo L loaded on the cargo handling device 5 through the flat plate portion 48. Therefore, it is possible to appropriately ensure the visibility of the space above the driver's seat 17, such as the cargo handling device 5, the cargo L that can be loaded on the cargo handling device 5, and a space below the cargo L (for example, the placement surface SHa of the shelf SH).

In addition, the central portion 44 of the protruding portion 41 may protrude upward in the left-right direction intersecting the front-rear direction. In this case, for example, since it is possible to reduce the amount of liquid flowing to the flat plate portion 48 in the liquid falling on the protruding portion 41, it is possible to have a structure in which the liquid is less likely to accumulate and to appropriately ensure the visibility of the upper portion.

In addition, the head guard 20 may further include the first water guiding portion 51 (water guiding portion 50) provided at the lower end portions of the protruding portion 41 and the flat plate portion 48 in the inclination direction T, extending in the left-right direction intersecting the front-rear direction, and capable of guiding water in the left-right direction, and the drain port 59 through which water can be drained from at least one end portion in the left-right direction may be formed in the pair of side plates 58 (water guiding portion 50). In this case, the head guard 20 can drain the liquid flowing from the protruding portion 41 and the flat plate portion 48 through the drain port 59 formed on at least one side in the left-right direction. Therefore, in the central portion 44 of the head guard 20 in the left-right direction, the possibility of liquid dripping can be reduced, and the visibility and comfort of the user U can be appropriately ensured.

In addition, the head guard 20 and the roof member 40 may further include: the extending portion 70 (first extending portion 71 and second extending portion 72) that is connected to the protruding portion 41 and the flat plate portion 48, is provided at at least one of both end portions of the protruding portion 41 in the left-right direction intersecting the front-rear direction, is inclined together with the protruding portion 41 and the flat plate portion 48 toward any one of the front side and the rear side in the front-rear direction, and extends in a flat plate shape along the flat plate portion 48; and the water guiding portion 50 (second water guiding portion 54) that extends in the front-rear direction in the extending portion 70 and the flat plate portion 48 and can guide water in the front-rear direction. In this case, since the extending portion 70 is inclined, a liquid on the extending portion 70 can be drained in the front-rear direction. In addition, the water guiding portion 50 (second water guiding portion 54) can receive a liquid flowing in the left-right direction from the protruding portion 41 via the extending portion 70 and a liquid flowing in the left-right direction from the flat plate portion 48, and can guide the liquid in the front-rear direction. Therefore, the possibility of liquid dripping can be reduced at at least one of both end portions of the head guard 20 in the left-right direction, and the visibility and comfort of the user U can be appropriately ensured. In addition, the second water guiding portions 54 are attached to the support member 30 with the roof member 40 sandwiched therebetween. Since the extending portion 70 extends in a flat plate shape, the second water guiding portion 54 is easily attached to the roof member 40 and the support member 30. In particular, when the support member 30 is a metal member such as iron, a portion where the fixing portion 56 is fixed (fastened) to the roof member 40 and the periphery of the portion have a flat plate shape, so that the second water guiding portion 54 can be easily fixed using the fixing portion 56.

The extending portion 70 may further include the third extending portion 73 connected to the protruding portion 41, the first extending portion 71, and the second extending portion 72 and provided behind the rear end portion 46 of the protruding portion 41. In this case, since the extending portion 70 is also inclined behind the protruding portion 41, the liquid on the extending portion 70 can be drained in the front-rear direction. Even if there is a liquid flowing from the third extending portion 73 to the rear side opposite to the inclination direction T, the water guiding portion 50 (third water guiding portion 55) can suppress (block) flowing down of the liquid to the rear side (rear combination lamp side). Therefore, the possibility of liquid dripping can be reduced behind the head guard 20, and the visibility and comfort of the user U can be appropriately ensured. In addition, the third water guiding portion 55 is attached to the support member 30 with the roof member 40 sandwiched therebetween. Since the extending portion 70 extends in a flat plate shape, the third water guiding portion 55 is easily attached to the roof member 40 and the support member 30. In particular, when the support member 30 is a metal member such as iron, a portion where the fixing portion 56 is fixed (fastened) to the roof member 40 and the periphery of the portion have a flat plate shape, so that the third water guiding portion 55 can be easily fixed using the fixing portion 56.

In addition, the head guard 20 may further include the support member 30 having a flat plate shape and supporting the protruding portion 41 and the flat plate portion 48 from below, and the protruding portion 41 and the flat plate portion 48 may be attached to the support member 30. In this case, since the protruding portion 41 and the flat plate portion 48 are attached to the support member 30 having a flat plate shape on the lower side, influence of unevenness in a configuration for supporting the protruding portion 41 and the flat plate portion 48 on the protruding portion 41 and the flat plate portion 48 is suppressed. Therefore, it is possible to suppress accumulation of a liquid in a part of the protruding portion 41 and the flat plate portion 48, and it is possible to improve mountability and sealability of the protruding portion 41 and the flat plate portion 48.

In addition, each of the protruding portion 41 and the flat plate portion 48 may constitute a part of the roof member 40 integrally molded with resin, the support member 30 may be a frame-shaped member in which one opening 30a penetrating in the up-down direction is formed, and the roof member 40 may cover the opening 30a of the support member 30 and be supported with the outer edge portion of the roof member 40 fixed to the support member 30. In this case, the protruding portion 41 and the flat plate portion 48 cover one large opening 30a formed in the support member 30 having a frame shape. That is, one opening 30a is covered with the roof member 40. As a result, narrowing of the field of view above the user U seated in the driver's seat 17 by the support member 30 is suppressed. In addition, for example, the roof member 40 is made of resin (made of polycarbonate) and thus is lightweight. Therefore, the support member 30 having a frame shape can support the roof member 40 having a large area. Furthermore, for example, one opening 30a larger than the driver's seat 17 in the front-rear direction and the left-right direction may be formed in the support member 30. In this case, since the roof member 40 is made of resin, the support member 30 having a frame shape can support the protruding portion 41 and the flat plate portion 48, and a wide field of view of the user U can be secured.

In addition, the head guard 20 may further include the bar member 35 that extends across at least one opening 30a of the support member 30 in the left-right direction intersecting the front-rear direction and is fixed to the support member 30. In this case, even when an impact is applied to the protruding portion 41 and the flat plate portion 48 due to a falling object or the like from above, bending of the protruding portion 41 and the flat plate portion 48 can be further suppressed.

In addition, a coating layer (the first coating layer 403 and the second coating layer 405) may be provided on at least one of the upper surface and the lower surface of each of the protruding portion 41 and the flat plate portion 48. The first coating layer 403 and the second coating layer 405 are made of, for example, a transparent resin, and can reinforce the roof member 40 made of resin and suppress deterioration of the substrate 401 of the roof member 40 due to ultraviolet rays. In addition, since the second coating layer 405 of the present embodiment includes the reflective particles 407 that reflect sunlight (infrared rays, visible rays, ultraviolet rays), a light collection suppressing effect can be further improved. In this manner, it is possible to suppress an increase in temperature inside the forklift 1 due to sunlight or the like transmitted through the protruding portion 41 and the flat plate portion 48, and to ensure excellent visibility and durability in the roof member 40.

Although various exemplary embodiments have been described above, the present disclosure is not limited to the above-described exemplary embodiments, and various omissions, substitutions, and changes may be made. For example, a plurality of openings 30a may be formed in the support member 30. The support member 30 and the roof member 40 may extend so as to be inclined downward toward the rear side. The protruding portion 41 may be inclined downward toward any one of the right side and the left side. That is, the central portion 44 may not protrude most upward. The protruding portion 41 may be inclined downward toward any one of the front side and the rear side. That is, the central portion 47 may not protrude most upward.

The roof member 40 may not have the extending portion 70. In this case, the head guard 20 may further include the second water guiding portion 54 (another water guiding portion 50) that is provided at at least one of both end portions of the protruding portion 41 and the flat plate portion 48 in the left-right direction, extends in the front-rear direction, and can guide water in the front-rear direction. In this case, the pair of second water guiding portions 54 may be attached to, for example, the right end portion 42 and the left end portion 43 of the protruding portion 41. The second water guiding portion 54 can receive a liquid flowing in the left-right direction from the protruding portion 41 and the flat plate portion 48 and can guide the liquid in the front-rear direction. Therefore, the possibility of liquid dripping can be reduced at both end portions of the head guard 20 in the left-right direction, and the visibility and comfort of the user U can be appropriately ensured. In addition, the third water guiding portion 55 may be attached to, for example, the rear end portion 46 of the protruding portion 41.

The second water guiding portion 54 and the third water guiding portion 55 may be formed of, for example, the same member. The flat plate portion 48 may be provided on at least one of the right side, the left side, and the rear side of the protruding portion 41.

What is claimed is:

1. A head guard of an industrial vehicle, comprising:
a protruding portion provided immediately above a driver's seat of the industrial vehicle having a cargo handling device capable of loading a cargo, the protruding portion protruding upward; and
a flat plate portion provided closer to the cargo handling device than the protruding portion and provided above the driver's seat, wherein
the protruding portion and the flat plate portion are both inclined toward any one of a front side and a rear side in a front-rear direction connecting the cargo handling device and the driver's seat, and at least the flat plate portion has visible light transmittance.

2. The head guard of the industrial vehicle according to claim 1, wherein a length of the protruding portion is longer than a length of the flat plate portion in the front-rear direction.

3. The head guard of the industrial vehicle according to claim 1, wherein a part of the flat plate portion is provided at a position intersecting a straight line connecting a position of a lower end of the cargo handling device or the cargo that can be loaded on the cargo handling device and an estimated position of a viewpoint of a user who can ride on the driver's seat.

4. The head guard of the industrial vehicle according to claim 1, wherein a central portion of the protruding portion protrudes upward in a left-right direction intersecting the front-rear direction.

5. The head guard of the industrial vehicle according to claim 1, further comprising
a water guiding portion provided at lower end portions of the protruding portion and the flat plate portion in an inclination direction, extending in a left-right direction intersecting the front-rear direction, and capable of guiding water in the left-right direction, wherein
a drain port through which water can be drained from at least one end portion in the left-right direction is formed in the water guiding portion.

6. The head guard of the industrial vehicle according to claim 1, further comprising another water guiding portion provided at at least one of both end portions of the protruding portion and the flat plate portion in a left-right direction intersecting the front-rear direction, the another water guiding portion extending in the front-rear direction and capable of guiding water in the front-rear direction.

7. The head guard of the industrial vehicle according to claim 1, further comprising:
an extending portion connected to the protruding portion and the flat plate portion and provided at at least one of both end portions of the protruding portion in a left-right direction intersecting the front-rear direction, the extending portion being inclined together with the protruding portion and the flat plate portion toward any one of the front side and the rear side in the front-rear direction and extending in a flat plate shape along the flat plate portion; and
a water guiding portion extending in the front-rear direction in the extending portion and the flat plate portion and capable of guiding water in the front-rear direction.

8. The head guard of the industrial vehicle according to claim 1, further comprising
a support member having a flat plate shape and supporting the protruding portion and the flat plate portion from below, wherein
the protruding portion and the flat plate portion are attached to the support member.

9. The head guard of the industrial vehicle according to claim 8, wherein each of the protruding portion and the flat plate portion constitutes a part of a roof member integrally molded with resin,
the support member is a frame-shaped member in which at least one opening penetrating in an up-down direction is formed, and
the roof member covers the opening of the support member and is supported by an outer edge portion of the roof member fixed to the support member.

10. The head guard of the industrial vehicle according to claim 9, further comprising a bar member extending across the at least one opening of the support member in a left-right direction intersecting the front-rear direction, the bar member being fixed to the support member.

11. The head guard of the industrial vehicle according to claim 1, wherein a coating layer is provided on at least one of an upper surface and a lower surface of each of the protruding portion and the flat plate portion.

12. An industrial vehicle comprising:
a driver's seat on which a user can ride;
a cargo handling device capable of loading a cargo; and
a head guard, wherein
the head guard includes
a protruding portion provided immediately above the driver's seat and protruding upward, and
a flat plate portion provided closer to the cargo handling device than the protruding portion and provided above the driver's seat,
the protruding portion and the flat plate portion are inclined toward any of a front side and a rear side in a front-rear direction connecting the cargo handling device and the driver's seat, and
at least the flat plate portion has visible light transmittance.

13. A roof member of an industrial vehicle, comprising:
a protruding portion provided immediately above a driver's seat of the industrial vehicle having a cargo handling device capable of loading a cargo, the protruding portion protruding upward; and
a flat plate portion provided closer to the cargo handling device than the protruding portion and provided above the driver's seat, wherein
the protruding portion and the flat plate portion are both inclined toward any one of a front side and a rear side in a front-rear direction connecting the cargo handling device and the driver's seat, and
at least the flat plate portion has visible light transmittance.
